(19) United States
(12) Patent Application Publication
(10) Pub. No.: US 2012/0169856 A1
(43) Pub. Date: Jul. 5, 2012

(54) SYSTEM AND METHOD FOR TIRE REGISTRATION

(76) Inventor: EVAN AHMED, Millstone Twp, NJ (US)

(21) Appl. No.: 13/341,531

(22) Filed: Dec. 30, 2011

Related U.S. Application Data
(60) Provisional application No. 61/428,633, filed on Dec. 30, 2010.

(51) Int. Cl. H04N 7/18

(52) U.S. Cl. 348/61; 348/E07.085

(57) ABSTRACT

The present application includes systems and methods for capturing information for registering the tires to enable submission of the registration information electronically. In order to capture the required information, embodiments utilize techniques to capture both information about an end-user, and information about a tire being purchased. Captured information may be populated into appropriate registration fields and sent to a third party in order to be utilized in the event of a tire recall or other emergency situation.

### CROSS-REFERENCE TO RELATED APPLICATION

This application claims priority to U.S. Provisional Patent Application No. 61/428,633 filed Dec. 30, 2010, entitled “SYSTEM AND METHOD FOR TIRE REGISTRATION,” the disclosure of which is hereby incorporated herein by reference in its entirety.

### TECHNICAL FIELD

The present application is directed generally toward product registration methods. More specifically, the present application is directed toward systems and methods which enable the efficient capture and distribution of tire registration information.

### BACKGROUND

In recent times hundreds of deaths and injuries on roadways have been recorded which are due to some form of tire defect. Accordingly, in the field of tire manufacturing and sales it has become increasingly important to take steps in order to ensure tire safety which includes the ability to recall tires in the event that a defect in a product is found. One step that has been taken has come in the form of a federal regulation which requires all tires to be registered and to include a Department of Transportation (DOT) serial number with the registration. This number may not be unique to a particular tire, but may rather correspond to a specific batch of tires which have been manufactured by a company.

Federal regulations require that either the retail store which sells the tires to an end-user, or the end-user themselves, must complete a product registration which includes the contact information of the consumer/user, information about a purchased tire, and the DOT number, see e.g., 49 C.F.R. §574.8. Unfortunately, compliance with these regulations is often lacking in the industry. This is likely due to the fact that completing the registration paperwork is undesirably burdensome for a retailer to undertake for every tire sold. This is especially true with high volume dealers. Moreover, the end-user will often not receive the proper paperwork needed to complete the registration from the retailer. And in the event that the paperwork is received, the end-user will often not undertake the effort to complete and mail the paperwork. As such, when a batch of tires is recalled by a particular manufacturer, it is difficult to notify all end-users of the tires of the potential safety hazards.

Currently there are two methods utilized to complete a tire registration. The first method is essentially a postcard method where a person fills in requisite information into respective fields of a postcard, e.g., the customer name, address, contact information, the dealer name, the DOT number, and additional serial numbers related to the tires, etc., see e.g., the exemplary form shown in FIG. 3. The second method includes an online tool where either the customer or retailer must type all of the information which would have been otherwise included in the postcard. However, as stated above, the use and compliance with these methods is often lacking in the industry. This is, in part, because oftentimes all of the required information is not readily available to a particular party at one time, thereby creating a hassle which many people are not willing to accommodate.

It is noted that oftentimes retailers will have the best access and infrastructure to consolidate all of the pertinent tire registration information. In fact, Federal Regulations appear to contemplate that part of the responsibility for tire registration should rest on the retailer. Currently, a retailer may be fined if they do not either register the purchased tire, or at least provide the end-user with the means to register the purchased tire. However, as discussed above, tire retailers often fail to undertake the responsibility for registering every tire sold to each of their customers because of the time/paperwork burden such an action has traditionally required. As such, the burden is placed on the individual consumer and/or goes unsatisfied.

### BRIEF SUMMARY

The present application is directed generally toward product registration methods and systems. More specifically, the present application is directed toward systems and methods which enable the efficient capture and distribution of tire registration information. Certain embodiments are directed to systems and methods for capturing information for registering tires to enable submission of the registration information electronically (e.g., to a centralized electronic repository, such as an electronic repository of the U.S. department of transportation or other tire registration authority). In order to capture the required information, certain embodiments disclosed herein utilize techniques to capture both information about an end-user (or “consumer”) and information about a tire being purchased.

Typically, information about the consumer of a tire is required for registration of the tire. The consumer is generally the person who purchases the tire(s) and on whose vehicle the tire(s) will be used, and thus the consumer is a person who it may be desirable to contact to inform of any manufacturer recalls of the tire(s), for example. In one embodiment, consumer information may be captured through a card reader, such as by swiping the magnetic strip of a credit card or driver's license or reading a radio frequency identification (RFID) chip contained within a consumer's card. With the read data, a consumer's information may be populated in an appropriate registration field. In another embodiment, consumer information may be imported from a point-of-sale system utilized by the retail establishment to track daily transactions. The consumer information in this embodiment may, for example, be existing customer information stored to an existing database within the point-of-sale system and may be read from such existing database.

Tire information may be captured using an optical means, in certain embodiments. For example, some embodiments may capture a digital image of at least a portion of a tire, e.g., the portion that includes the DOT number. With that captured image, certain embodiments may utilize optical character recognition (OCR) or other techniques to enable a system to populate an appropriate registration field. Furthermore, in some embodiments, the device used to capture tire information may also include the mechanism for capturing consumer information (e.g., a credit card or driver's license reader).

Another example embodiment may capture tire information via an RFID reader. In this embodiment the tire may include some form of RFID tag, and the system may include a device configured to read information from the RFID tag. Subsequently, the tire information may be populated into an appropriate registration field.

In some embodiments, the capture device and the software to recognize information from the captured image may be included on a single device, such as an application-specific hand-held device or a readily available smart phone or other hand-held processor-based communication device (e.g., devices such as iPod™, Android™, iPhone™, iPad™, Blackberry™, etc.) configured to execute an application sufficient to implement the proposed methods. For instance, a mobile device, such as a mobile telephone (e.g., an iPhone or other smart phone device), may be implemented in certain embodiments to include a means for capturing the consumer information (e.g., a credit card or driver's license reader) and a means for capturing tire information (e.g., a camera or RFID reader).

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIG. 1 illustrates an exemplary overall system in accordance with one embodiment of the present invention;

FIG. 2 illustrates a method flowchart in accordance with one exemplary embodiment of the present invention.

FIG. 3 shows an exemplary traditional tire registration form;

FIGS. 4-18 show exemplary user interface screen shots for one implementation of a mobile application for tire registration in accordance with one embodiment of the present invention.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

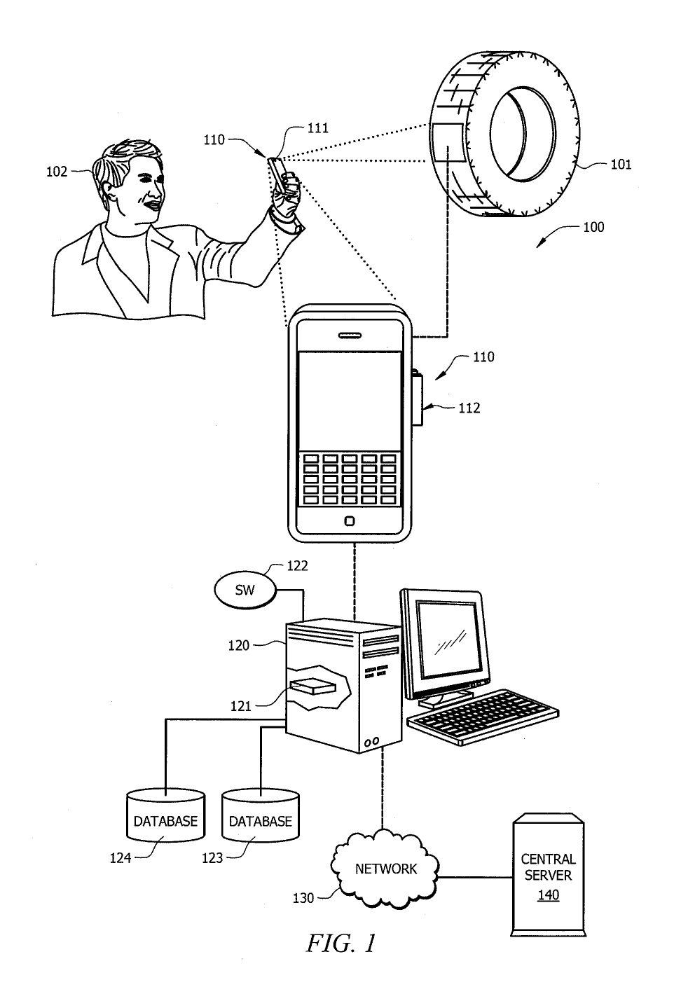

FIG. 1 illustrates an exemplary overall system 100 for efficient tire registration in accordance with an embodiment of the present invention. System 100 includes an exemplary mobile (e.g., hand-held) capture device 110 which includes a tire information capture component 111 and a consumer (or “customer”) information capture component 112. Device 110 is a processor-based device, like a smartphone for example. Tire information capture component 111 is used to capture information corresponding to tire 101, and tire information capture component 111 generally refers to corresponding components within device 110 that may be used for capturing tire information in any of the ways described further herein. Tire information capture component 111 may, in certain embodiments, comprise a digital image capture device, such as a camera, an RFID scanner, infrared scanner, and the like. Any means capable of obtaining information for registration purposes may be used in alternative embodiments, preferably means capable of capturing information without requiring manual input of such information by a user of hand-held device 110. Of course, as described further herein, a manual input means (e.g., keyboard, such as a touch-screen keyboard interface) may also be included in certain embodiments to allow for input of tire registration information and/or for manual editing of tire registration information that is captured autonomously, such as by a digital image capture device).

In this exemplary embodiment, hand-held capture device 110 also includes consumer information capture component 112. Consumer information capture component 112 is used to capture information about consumer 102 that is needed for tire registration, and consumer information capture component 112 generally refers to corresponding components within device 110 that may be used for capturing such consumer information in any of the ways described further herein. Consumer information capture component 112 may, in certain embodiments, comprise a card reader which allows a user to obtain information regarding consumer 102 using a swipe of a credit card, drivers license, and the like. Consumer information capture component 112 may also comprise a manual entry means such as a keyboard. Such a manual entry means may be implemented, for example, as a touch screen on hand-held capture device 110, or as a keyboard component implemented on the hand-held capture device 110. A manual entry means may also comprise a microphone along with voice recognition software which may be used to dictate consumer information to consumer information capture component 112. It is also noted that consumer information may be captured by using a combination of methods such as a swipe of an identification card for capture of certain consumer information along with manual entry of certain other consumer information. In another example embodiment, consumer information may be captured using an RFID scanner to capture information such as is included in RFID chips located on certain consumer credit cards and the like. In this embodiment, the RFID scanner may be the same scanner utilized with tire information capture component 111. Thus, in certain embodiments the tire information capture component 111 and consumer information capture component 112 may be or include the same elements/components (as in the above-mentioned exemplary implementation wherein an RFID scanner is employed to capture both tire information and consumer information). Further, a manual input means (e.g., keyboard, such as a touch-screen keyboard interface) may also be used in certain embodiments to enable manual editing of consumer registration information that is captured autonomously, such as by a card reader or RFID scanner).

In certain embodiments, in response to a consumer 102 purchasing a tire 101 from a retailer, the mobile device 110 may itself execute software for completing an electronic tire registration form, or the mobile device 110 may communicatively couple with another computer, such as computer system 120 discussed below, for completing such electronic tire registration form. For instance, in certain embodiments, consumer information captured by consumer information capture component 112 of mobile device 110 may be used (e.g., either by software executing on device 110 or on another computer system with which mobile device 110 at least temporarily communicatively couples) to automatically populate certain registration fields with information about consumer 102, and tire information captured by tire information capture component 111 of mobile device 110 may be used (e.g., either by software executing on device 110 or on another computer system with which mobile device 110 at least temporarily communicatively couples) to automatically populate certain registration fields with information about tire 101, thereby facilitating an efficient and user-friendly tire registration process.

In certain embodiments, mobile device 110 is a device used by an employee of a tire retailer to facilitate the efficient registration of tire(s) being purchased by consumer 102. For instance, in one embodiment an employee of a tire retailer may use mobile device 110 to capture tire information (via tire information capture component 111) about tires being purchased by consumer 102, as well as to capture information about consumer 102 (via consumer information capture component 112). This may be performed in certain embodiments as part of a sales transaction (e.g., a check-out or point-of-sale transaction) conducted with the consumer 102. Thus, the tire registration may be performed easily and efficiently, without requiring that the consumer 102 or the tire retailer take a lot of extra steps to complete the tire registration process (such as manually filling out a form or postcard, as in traditional registration processes).

In some embodiments, system 100 further includes computer system 120, which may be a tire retailer's computer system. Computer system 120 may include a processor 121 which executes software stored in a computer-readable storage medium 122. Computer system 120 may be configured to receive information from mobile capture device 110, and populate such information into a format usable for registering tire 101. Such information may be transmitted via a wireless local area network (LAN), Bluetooth connection, direct cable connection, and the like. Additionally, in some embodiments computer system 120 may include a docking system to receive mobile device 110, such as a universal serial bus (USB) interface with computer system 120. Such a docking system may function to synchronize information and/or to charge mobile device 110. It is noted that tire information capture component 111 and consumer information capture component 112 may be part of a single processor-based device 110, as shown in the exemplary embodiment of FIG. 1, or may be included in separate devices in alternative embodiments. For example, consumer information capture component 112 may, in alternative embodiments, be included as part of computer system 120, instead of or in addition to being included as part of mobile device 110.

In some embodiments, computer system 120 may be part of an overall point-of-sale system within a tire retailer. In general, tire retailers obtain consumer information prior to beginning any work on a consumer's vehicle. Such information may be obtained/captured by and/or input to computer system 120. This information may be imported into appropriate registration fields for later use. Computer system 120 may also be in communication with consumer (or “customer”) database 123 and tire information database 124. Consumer database 123 may include consumer information, such as information obtained from a point-of-sale system or information stored from previous consumer interaction, such as from previous sales transactions the consumer has had with the retailer. Tire information database 124 may include information relating to tires in inventory of a retailer. Such information may be entered into the database 124 upon receipt of the tires into the retailer's inventory either manually or by utilizing a device such as hand-held device 110 having tire information capture component 111. In some embodiments, computer system 120 may link information from tire information database 124 and consumer database 123 and utilize such information for tire registration purposes. For instance, software 122 may execute on computer system 120 to, in response to a consumer 102 purchasing a tire 101 from a retailer, enable consumer information from database 123 to be used to automatically populate certain registration fields with information about consumer 102 and to enable tire information from database 124 to be used to automatically populate certain registration fields with information about tire 101, thereby facilitating an efficient and user-friendly tire registration process.

Computer system 120 and/or mobile device 110 may be further configured to transmit tire registration information over network 130 to a central server 140. Network 130 may comprise a network which connects multiple tire retailer locations. Additionally, network 130 may be a communication medium such as the Internet, a cellular network, or a public switched telephone network, as examples. Central server 140 may comprise a central database configured to store registration information and utilize such information in the event that manufacturer recalls of tires are implemented. The central server may thus serve as a repository of electronic, computer-readable information for the tire retailer and/or for a tire registration authority, such as the U.S. department of transportation, as examples. In this way, in certain embodiments, the tire registration information may be submitted electronically (via communication network 130) to a tire registration authority (e.g., the U.S. department of transportation).

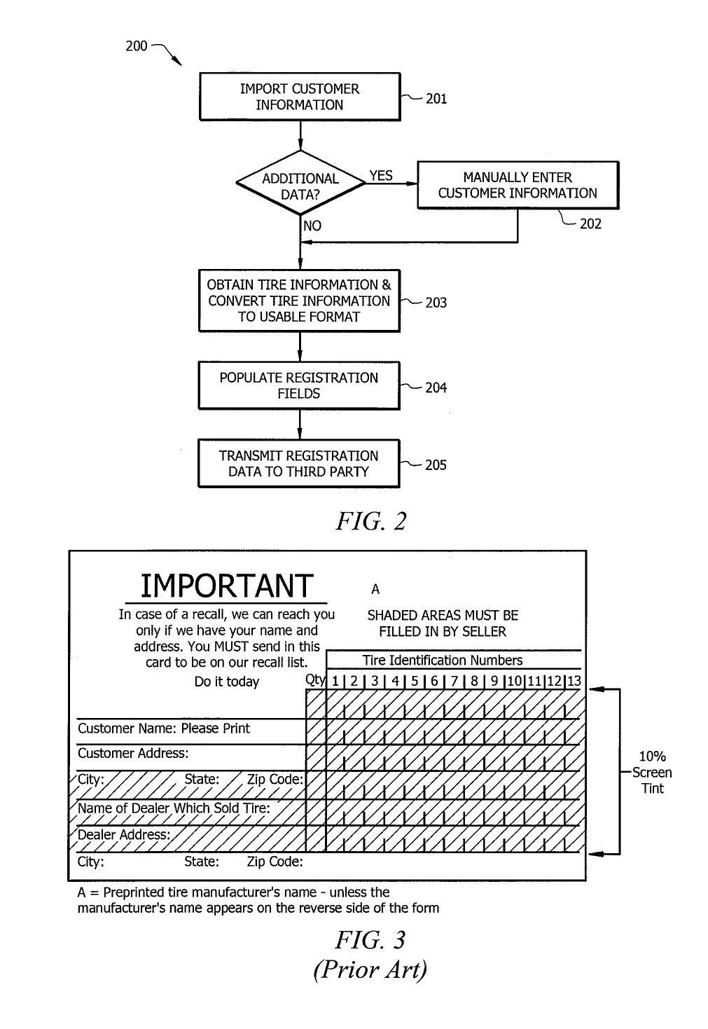

FIG. 2 illustrates a method 200 flowchart in accordance with one exemplary embodiment of the present invention. In method 200, when the consumer buys tires, consumer information is imported/captured by a capture device of mobile device 110, such as a card scanner, RFID scanner, etc., as discussed above with consumer information capture component 112 of FIG. 1. Additional consumer information may be manually entered to mobile device 110 and/or the captured information may be manually edited, if desired at 202. Information that may be manually entered in certain embodiments may include information that may not be automatically captured by the capture device in operation 201. In certain implementations the manually entered information may include an email address or cell phone number information for the consumer to enable alerts to be sent to the consumer via e-mail, telephone, SMS text, etc., in the event of a recall or an emergency relating to the tire(s) purchased by the consumer.

Information about a tire is obtained either prior to or at the point-of-sale at 203. To obtain such information, a user (e.g., an employee of a tire retailer or other user of mobile device 110) may be first directed to select the type of tire that is being purchased by the consumer. The user may then import/capture information from the specific tire at 203. This may be accomplished by any suitable capture means, such as taking a digital picture of the unique DOT number, reading an RFID, and the like. As discussed above with FIG. 1, a tire information capture component 111 of mobile device 110 may be used to capture such tire information in block 203. The imported information may be converted into a usable format (e.g., to a text format, rather than an image format) by performing a recognition algorithm such as by using OCR software. It is noted that separate information imports/captures for individual tires may not be necessary in certain embodiments. For example, in the event that a consumer purchases four tires of the same brand, in many such instances the tires will have the exact same DOT number because they were manufactured contemporaneously.

Once the consumer information and tire information are compiled, the information may then be populated into registration fields in block 204. In certain embodiments, additional information may be entered into corresponding registration fields, such as information identifying the tire retailer from whom the tires are being purchased. Such additional information may be manually entered and/or may be automatically populated (e.g., from pre-stored database information that identifies the tire retailer) into the corresponding registration fields. According to certain embodiments, the tire registration information (e.g., the captured/entered customer information and the captured tire information, and any other tire registration information such as the above-mentioned identification of the tire retailer) may be transmitted in block 205 from mobile device 110 or from a computer system 120 to a third party, such as to either a central server, or to each individual tire manufacturer. These various entities may then utilize the information to contact individual customers in the event of a recall relating the tire purchased by the consumer.

Many of the elements described herein, when implemented via computer-executable instructions, are in essence the software code defining the operations thereof. For instance, mobile information capture device 110, computer system 120, and central server 140 of FIG. 1 may each comprise computer-executable software code that is stored to a computer-readable storage medium and is executed by a processor for performing the corresponding operations described herein. Further, the various operations described herein, such as those operations described with reference to the exemplary flow of FIG. 2, as well as other operations described herein for performing tire registration, may be performed by computer-executable software code stored to a computer-readable storage medium and executing on a processor-based computing device. The executable instructions or software code may be obtained, for example, from a computer-readable storage medium or “storage device” (e.g., a hard drive media, optical media, EPROM, EEPROM, tape media, cartridge media, flash memory, ROM, memory stick, and/or the like), and may be executed by a processor-based device, such as mobile information capture device 110 and/or computer system 120, for performing the operations described herein.

According to certain embodiments of the present invention, the software instructions/routines are implemented as a computer program product that can be installed to a processor-based device (e.g., mobile information capture device 110 and/or computer system 120) by any suitable software installation procedure, as is well known in the art. In another embodiment, at least a portion of the software instructions may also be downloaded via a communication network (e.g., network 130) over a cable, communication and/or wireless connection.

All or a portion of the software instructions and/or data (e.g., captured consumer and tire registration data/information) may be communicated (e.g., across network 130 and/or within a given computer device) as signals propagating on a carrier or propagation medium. As used herein, a “computer-readable storage medium” refers to a tangible storage medium, such as a hard disk, ROM, RAM, flash memory device, magnetic memory device, and is not intended to refer merely to a propagating signal.

In certain embodiments, a CPU of a computing system or processor-based device may execute the various logical instructions according to embodiments of the present invention. For example, CPU(s) of mobile information capture device 110 and/or computer system 120 may execute machine-level instructions according to the exemplary operational flow described above in conjunction with FIG. 2. It shall be appreciated that the present invention is not limited to the architecture of the computing system or device on which the various elements are implemented, such as any particular architecture of a mobile information capture device 110 or computer system 120. The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein, as examples. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

One exemplary implementation of a computer program product (e.g., a mobile software application) in accordance with one embodiment of the present invention is described further below.

According to one exemplary implementation of an embodiment of the present, a mobile software application (or “mobile app”) is implemented on a user's mobile device (e.g., smartphone) and functions to make it easier and more efficient for consumer and tire information to be captured and uploaded to auto manufactures using such mobile (e.g., “hand-held”) device. With use of this exemplary application, in a few “clicks” (e.g., mouse clicks or finger touches to a touch-screen) the tire registration information can be captured, traversed and uploaded into the appropriate database. The mobile application may be installed to a processor-based device (e.g., a mobile device, such as device 110 of FIG. 1) by any suitable software installation procedure, as is well known in the art, such as via a download over a communication network (e.g., network 130) from an application store available on a computer server.

The exemplary mobile application described below enables users (e.g., tire dealers and tire distributors) to register the tires they sell via their mobile devices, such as their iPhone and iPad devices.

Traditionally, users have had to manually fill in a form, such as the form shown in FIG. 3, in order to register tires purchased by consumers.

The exemplary mobile application enables easy and efficient collection of all the information which should be placed in this traditional tire registration form electronically, such that it can be communicated and stored on a server side, such as within a central server 140 of FIG. 1.

In this exemplary embodiment, a dealer's (or retailer's) details/information is collected during a Dealer registration process. A consumer's details/information will be obtained from the consumer's driver license, and the tire information will be captured from the manual entry of tire numbers and/or from an image capture (e.g., photo) of information contained on the purchased tire(s). A dealer registers in the application and launches new data. The dealer (e.g., an employee of the dealer who is using mobile device 110) scans the consumer's drivers license via a card reader device coupled to the mobile device 110. In one embodiment, a Linea Pro iPod card reader (http://www.ipcprint.com/mobile/wp-content/uploads/lineapro4/docs/linea pro 4 manual a6 v1.pdf) is coupled to the mobile device 110 and is used for capturing information from the consumer's drivers license. Of course, other magnetic stripe readers may be used in place of the Linea Pro in alternative embodiments.

When the consumer's drivers license information is scanned it is recognized (e.g., using Driver's License Component for Software Developers (SDK) V4.21.2), and the recognized data may be displayed on the screen of the mobile device 110.

When a user (e.g., a retailer/dealer's employee) desires to use the mobile application on mobile device 110, the user taps on the application icon to cause the application to be launched in a traditional manner. The first screen which is shown to the user in this exemplary embodiment is a Splash screen (e.g., a static image), which is shown during some launch period (e.g., 2 seconds) while the application is being launched.

Thereafter, a Login screen is presented to the user on the display of the mobile device 110. In this exemplary embodiment, the login screen contains the following information:

1) An application logo;

2) A textbox with the “Username” text. Once a user clicks this field the default iPhone keyboard appears and a user is able to enter his username (minimum 6, maximum 100 characters) to the field. This field is obligatory.

3) A textbox with the “Password” text. Once a user clicks this field the default iPhone keyboard appears and a user is able to enter his password (minimum 6, maximum 50 characters) to the field. The application will display the masked (by *) specified data instead of the “Password” text. This field is obligatory.

4) A “Remember me” checkbox. If a user ticks the checkbox the application will remember the username and password specified so that it might display them when a user loads the application again. As default the “Remember me” option will be checked.

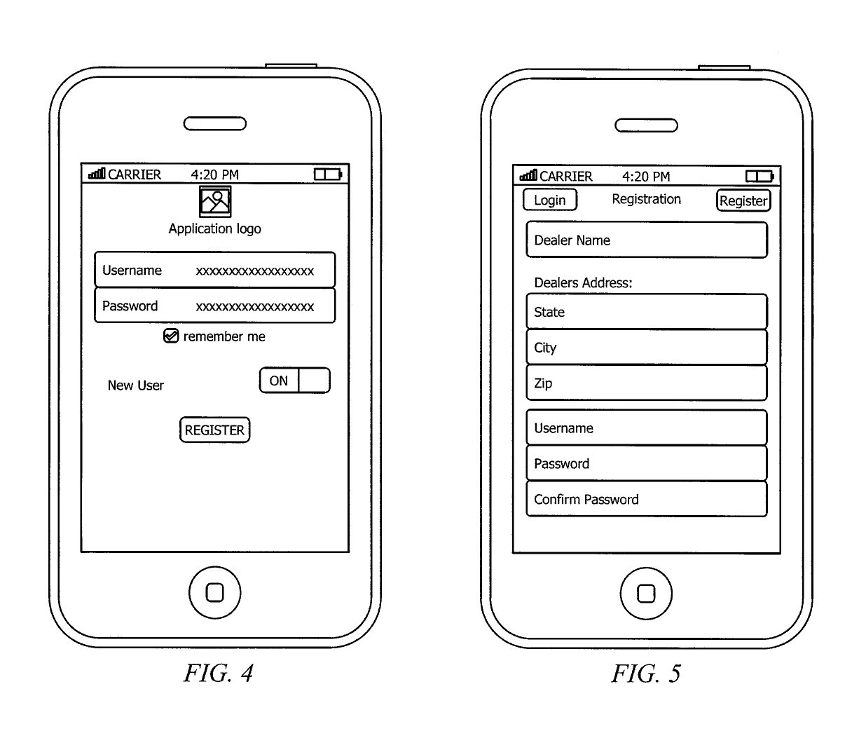

5) The “New User” switch-box. It is switched to “OFF” by default. If a user turns it to “ON” the “Login” button is replaced with the “Register” button (see FIG. 4). When a user clicks “Register” he is redirected to the screen presented in FIG. 5.

6) The “Login” button. When a user taps it the application will check if the username and/or password correspond to these fields requirements. If they do not, the application will display an indication that the corresponding field of the login information is incorrect. If they are valid, the application will send a query to the server. If the application gets an answer with an error about the failed authorization, a notification message (“Invalid email and/or password”) will be displayed under the Email and/or Password textboxes. If the application gets an answer with any other errors, a notification message (“Sorry, you can't log in now, please try again latter”) will be displayed under the Email and/or Password textboxes. If the application gets an answer that the authorization has been successfully done, the application will display the New data input introduction screen (FIG. 5).

In order to log out from the application a user clicks a Logout button shown on the application's user interface.

When a new user clicks the “Register” button in FIG. 4, the screen presented in FIG. 5 will be opened. As shown in FIG. 5, this screen contains the following fields:

1) The “Registration” header.

2) The “Dealer's name” text field (maximum 250 characters). The field is obligatory. When a user taps any of the input fields the default iPhone keyboard appears.

Dealer's Address info:

3) The “State” text field (maximum 250 characters). The field is obligatory.

4) The “City” text field (maximum 250 characters). The field is obligatory

5) The “ZIP” text field (maximum 250 characters, just numerals). The field is obligatory.

Dealer's Login info:

6) The “Username” text field (minimum 6, maximum 100 characters). If a “Username” was entered by a user in FIG. 4 the “Username” field will be filled in with that data. The field is obligatory.

7) The “Password” text field (minimum 6, maximum 100 characters). If a “Password” was entered by a user in FIG. 4 the “Password” field will be filled in with that password. The field is obligatory.

8) The “Confirm Password” text field (should match the Password field). The “Password” and “Confirm the password” fields will be highlighted with the green color if they match or with the red one if they don't. The field is obligatory.

9) The “Login” button. When clicking it a user is redirected to the Login screen for entry of his/her username and password.

10) The “Register” button. In order to confirm registration the “Register” button should be clicked by a user. Once it happens every field on the screen will be checked if it corresponds to the field requirements. If it does not, the application will display FIG. 5 and mark the corresponding field as a wrong one (it will be highlighted with the red color). If the fields are valid a new account will be successfully created and a user will be redirected to the New data input introduction screen.

When a user clicks the “Login” button on the Login screen or the “Register” button in FIG. 5, the user is redirected to the New data input introduction screen. This screen contains an introduction text along with a description of how to use the application, it will be scrollable. The screen will be displayed in case:

1) A user loads the application for the first time.

2) A user selected the “Show Intro screen by each app launch” check-box. It will be unchecked by the default.

When the user clicks the “Start” button, the scanning hardware will be launched and when a user holds a drivers license to it, a screen is presented to inform the consumer that the drivers license information is being read in so that the consumer knows the device is working on this process. If the user clicks the “Cancel” button, the application will be closed.

Again, once the scanning hardware is launched and its work is in progress, the screen informing the user that the drivers license information is being read in is displayed. This screen will be displayed for the time it that the scanning takes. This screen will contain:

1) The “Scanning in process” header.

2) The following static text: “Please wait while recognizing the data from your Driver License . . . it may take a few minutes”.

3) A progress bar which indicates the driver license recognition progress.

As is described in the manual, IDScan_SDK_for_iPhone&iPod_-_Manual.pdf, the following list of fields will be obtained as a result of the driver license scanning:

LastName

FirstName

MiddleName

City

PostalCode

Country

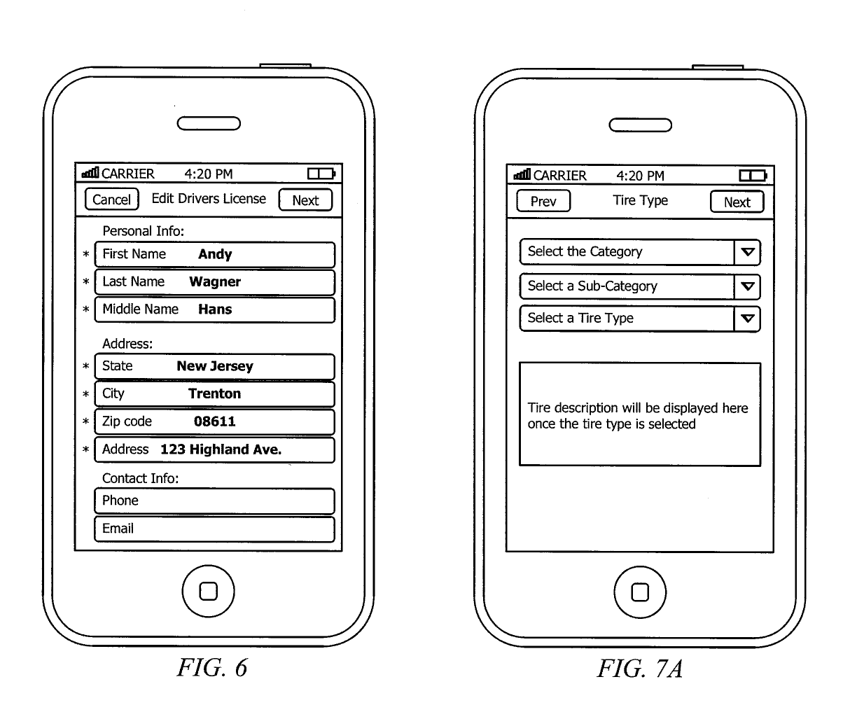

All the fields mentioned above will be placed in the corresponding fields as it is shown in FIG. 6 after the drivers license has been scanned. If any required information from the drivers license cannot be recognized by the OCR software, the following message will be displayed on the screen of the mobile device 110: “Information from the License can't be recognized. Please try to scan one more time”.

After the data from the drivers license has been successfully recognized, the screen presented in FIG. 6 will be automatically opened (it will be filled in with the data taken from the license). All the displayed fields are editable. The default iPhone keyboard will appear once any of the text input fields is tapped by a user.

In this exemplary embodiment, this screen (as shown in FIG. 6) contains the following elements:

1) The “Edit the Driver License” header.

2) The “First Name” text input field (maximum 100 characters). The field is obligatory.

3) The “Last Name” text input field (maximum 100 characters). The field is obligatory.

4) The “Middle Name” text input field (maximum 100 characters). The field is obligatory.

5) The “Country” text field (maximum 100 characters). The field is obligatory.

6) The “City” text field (maximum 100 characters). The field is obligatory.

7) The “ZIP Code” text field (maximum 100 characters, just numerals). The field is obligatory.

8) The “Phone” text field (maximum 100 characters, just numerals). The field is optional.

9) The “Email address” text field (maximum 100 characters, email validation is required). The field is optional.

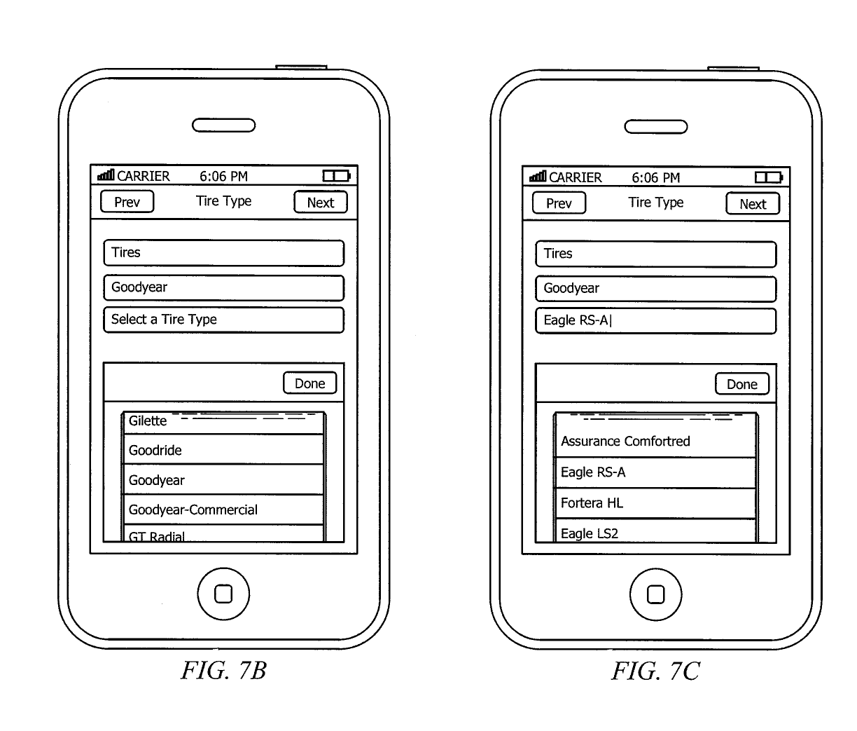

The “Next” button will be non-active until all obligatory fields are filled in. When the “Next” button becomes active and a user clicks it, the fields corresponding to their requirements will be checked. If they are filled in correctly, a user will be redirected to the screen presented in FIG. 7A. Otherwise, incorrect or blank fields will be highlighted with the red color, and the “Next” button will still be inactive.

Once the consumer information is populated, the user may click the “Next” button to proceed with the tire registration process. When a user clicks the “Next” button in FIG. 6, the user will be directed to the screen presented in FIG. 7A. This screen contains the following elements:

1) The “Tire type” header.

2) 3 drop-down menus: “Category”, Sub-category and “Tire type”. The items displayed in each subordinate drop-down menu will depend on the item selected above. When a tire type is selected its description is displayed in the section below. The tire type selection is obligatory.

3) The “Prev” button. When clicking it a user is directed to the screen presented in FIG. 6.

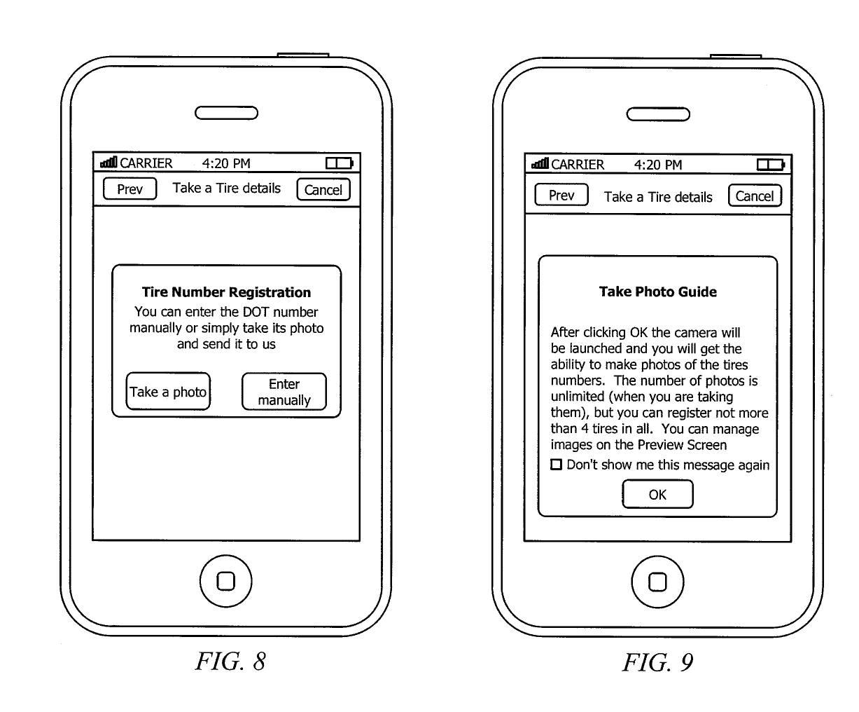

4) The “Next” button. When the button becomes active and is clicked a user is directed to the screen presented in FIG. 8.

FIG. 7B shows an example where the category selected is “Tires,” and the sub-category provides a drop-down menu that provides a list of various different tire manufacturers, such as Gilette, Goodride, Goodyear, etc. In this illustrated example, the sub-category of “Goodyear” is selected. Then, in FIG. 7C, the “Tire type” provides a drop-down menu of different makes of tires provided by the selected manufacturer. In the illustrated example, the tire type of “Eagle RS-A” is selected as the make of Goodyear tire that the consumer is purchasing. The list of tire manufacturers provided in the drop-down category menu and the list of tire types provided in the drop-down tire type menu may be read, for example, from database (e.g., residing on mobile device 110 or on computer 120) of manufacturers and tire types that are available for purchase from a given retailer. The tire type information may be into the screens of FIGS. 7A-7C by a user of mobile device 110 (e.g., through a keyboard or touch-screen interface).

When a user clicks the “Next” button in FIG. 7C the dialogue presented in FIG. 8 will be opened. This dialogue contains the following text: “Tire Number Registration. You can enter the DOT number manually or simply take its photo and send it to us”. Two options are available:

1) When a user clicks the “Take a photo” button the dialogue presented in FIG. 9 will be opened.

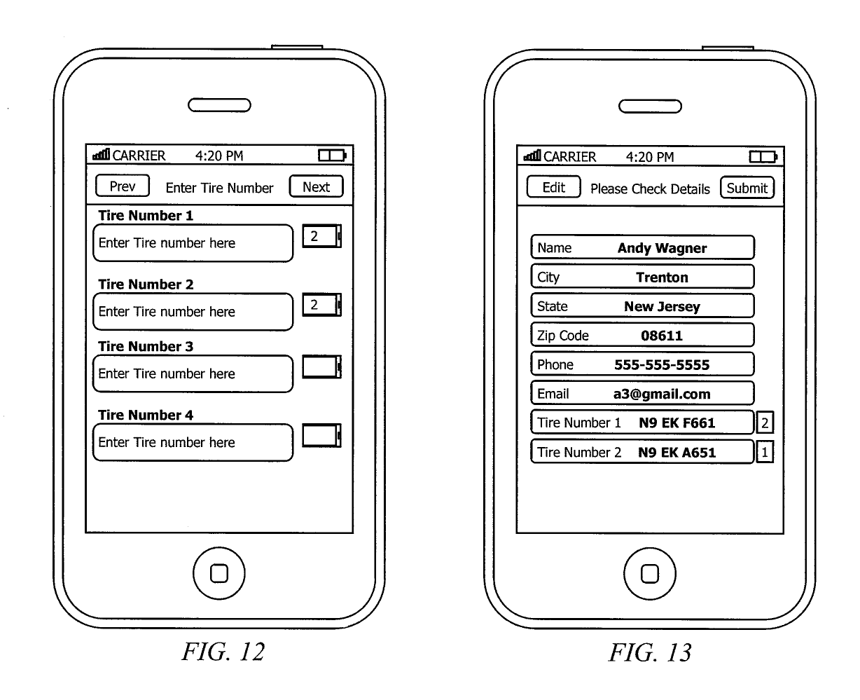

2) When a user clicks the “Enter manually” button the screen presented in FIG. 12 will be opened.

In certain embodiments, if the DOT number is available on a bar code that can be scanned or is included in information communicated by a RFID tag included in or with the tire, that information may be scanned by a bar code reader or a RFID scanner that may be included in the mobile device 110 (e.g., as part of tire information capture component 111. Thus, in certain embodiments, the mobile device 110 may read the DOT number associated with a given tire via one or more of digital image capture (as shown in FIG. 9), bar code scanner, RFID reader, or manual entry.

Also the screen shown in FIG. 8 contains the following elements:

1) The “Take a Tire details” header

2) The “Prev” button. When clicking it a user is directed to the screen presented in FIG. 6.

3) The “Cancel” button.

The screen presented in FIG. 9 will be opened in case a user clicks the “Take a photo” button in FIG. 8. The screen in FIG. 9 contains a confirmation dialogue with the following static text: “After clicking OK the camera will be launched and you will get the ability to make photos of the tire numbers. The number of photos is unlimited (when you taking them) but you cannot register more than 4 tires in all during a single registration operation. You can manage images on the Preview screen”. The “Don't show this message again” check-box is shown in the message. It's unchecked by default. If the check-box is ticked by a user the dialogue will not be displayed next time a user launches the application. When a user clicks “OK” the dialogue is closed and a camera included in the mobile device 110 is turned on.

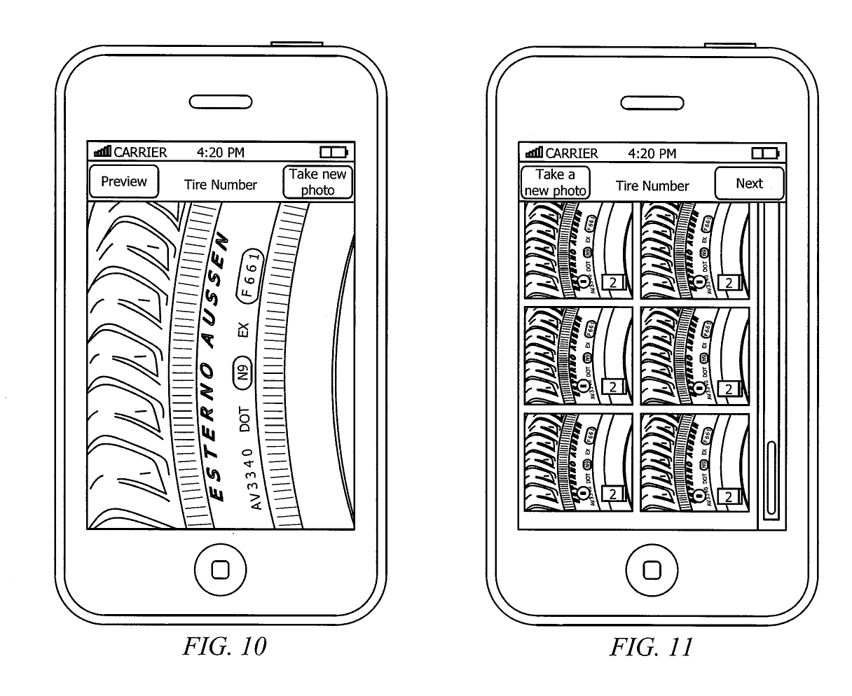

Once a photo is made, it will be displayed as it is shown in FIG. 10. This screen contains a photo and 2 buttons: “Take a new photo” and “Preview”. When a user clicks the “Take a new photo” button, the camera will be turned on again. The previous photo will be saved in the device memory and a new one will be taken. An unlimited number of photos can be taken, so long as sufficient memory is available on mobile device 110 for storing the photos.

When a user clicks the “Preview” button he is directed to the screen presented in FIG. 11. This screen contains all photos taken by a user at the stage of taking tire numbers. The following elements are placed on the screen:

1) The “Tire number” header.

2) The “Take a new photo” button. When clicking it the camera will be turned on and a new photo will be taken as shown in FIG. 10.

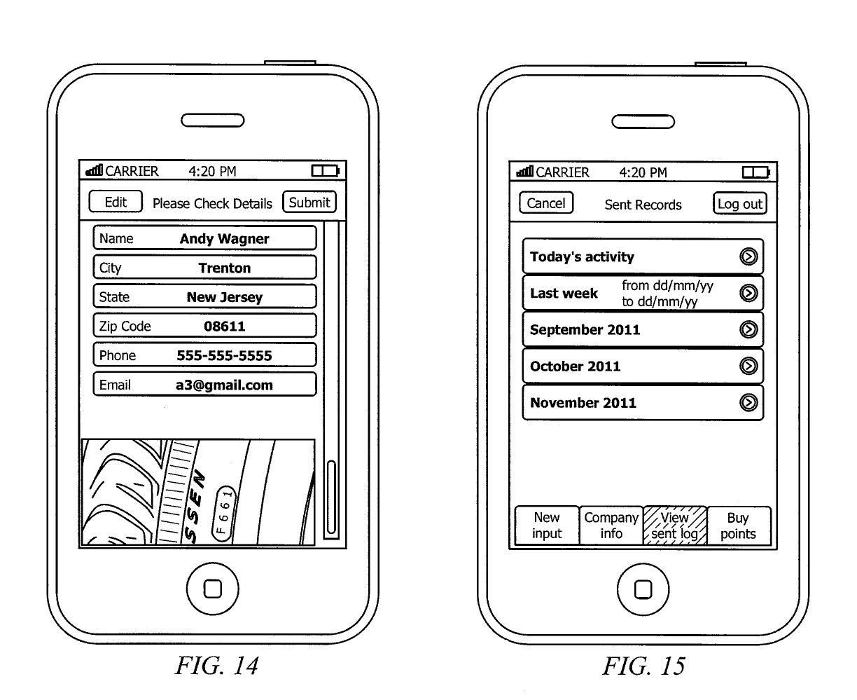

3) The “Next” button. When clicking it a user is directed to the screen presented in FIG. 14.

The screen is scrollable. Each photo displayed on the screen contains the Delete button and a drop-down menu with pictures from 1 to 4. When clicking the Delete icon the image will be removed from the device memory and from the preview screen as well.

Sometimes all 4 tires can have the same tire number and sometimes all tire numbers are different. Therefore, a user has an option to choose the number of tires he wants to register. The drop-down menu is related to each image taken by a user. When a user chooses two (2) in the dropdown menu it means that there will be two tires with the same number. The number of tires registered per one data input cannot exceed four in this exemplary embodiment, therefore when a user tries to register more than four tires (by choosing values in the drop-down menu) the following message is displayed: “The number of tires registered per one data input can't exceed 4. Please change the number using the drop-down menu”. The default value for each drop-down menu is 1.

When a user clicks “Enter manually” in FIG. 8 the screen presented in FIG. 12 will be opened. This screen contains the following elements:

1) The “Enter a Tire Number” header.

2) 4 “Tire Number” text input fields. A tire number will be entered to this field. The “Number of tires” drop-down list is related to each text field. Values from 1 to 4 will be listed there. 1 will be selected as a default value. In case there are 3 tires with the same number a user needs to enter a tire number and choose 3 in the dropdown list. The number of tires registered per one data input cannot exceed 4, in this exemplary embodiment, therefore when a user selects, for example, 4 identical tires in the first drop-down list and tries to enter one more tire number the following message will be displayed: “The number of tires registered per one data input can't exceed 4. Please change the number using the dropdown lists”.

At least one tire number should be entered to the text input field. The “Next” button will be inactive until a user enters the tire number/s. When the “Next” button becomes active and it is clicked a user is directed to the screen presented in FIG. 13. When a user clicks “Prev” he is directed to the screen presented in FIG. 8.

When a user clicks the “Next” button in FIG. 12 the screen presented in FIG. 13 will be opened. The preview screen will be opened in the read-only mode. A user can review the fields without editing them, this screen is scrollable. In order to edit any info the “Edit” button should be clicked. Once it is, the “Edit” button will be replaced with the “Save” one and all fields described below will become editable. When a user clicks “Save” the changes made will be saved. The following fields will be presented on this screen:

1) The “Name” text field (maximum 100 characters). The field is obligatory. Here can be displayed the First and the Second name or the Company name (the license can contain one of these values).

2) The “City” text field (maximum 100 characters). The field is obligatory.

3) The “State” text field (maximum 100 characters). The field is obligatory.

4) The “ZIP Code” text field (maximum 100 characters, just numerals). The field is obligatory.

5) The “Phone” text field (maximum 100 characters, just numerals). The field is optional.

6) The “Email address” text field (maximum 100 characters, the email validation is required). The field is optional.

7) The “Tire number” text field (maximum 100 characters). The field is obligatory. The textbox which reflects the number of tires with this number is displayed related to each text-box.

If a user has taken a photo of tires instead of entering numbers manually the “Preview screen” will look like in FIG. 14. This screen will contain the images of tires displayed below the text fields. The screen will be scrollable. When a user clicks the “Submit” button in FIG. 13 or 14 a “Congratulations” screen may be presented. In case the data cannot be submitted to the server due to the troubles with the interne connection there will appear the following alert: “The data can't be submitted to the server right now. The data will be stored in the device memory. You can try to submit it later”. The data will be stored in the phone memory and listed in the application on the screen as shown in FIG. 15. The records submitted will be displayed for a user having “administrator” rights, as described further herein.

If this is the first attempt to submit the data to the server or a user does not have any points on his account (in the case where the user has bought a subscription as discussed further herein) the screen presented in FIG. 17 will be displayed once the “Submit” button in FIG. 13 or 14 is clicked.

In this exemplary embodiment, a user is offered an option to buy a subscription for use of the tire registration application. The dialogue presented in FIG. 17 will be opened in case:

1) A user clicks the “Submit” button in FIG. 13 or 14 by the first attempt to submit the data.

2) A user clicks the “Buy points” menu item in the navigation menu of the application's user interface.

This dialogue will contain the following information:

1) The following static text: “Confirm your in-app purchase. In order to submit the data to the server the package should be bought. You can choose one of the options below”.

2) The options are: “30 cents per tire” and “monthly unlimited plan”. One of the options can be selected using the radio-buttons. The “monthly unlimited plan” value will be selected by default (as it is shown in FIG. 17). When a user chooses “30 cents per tire” in FIG. 17 the text input field will be placed related to this radio-button, which will allow a user to choose a number of options he wants to buy (just numerals). 1 value will be displayed here by default.

3) The “Cancel” button. When clicking it the following alert will appear: “The data you've specified will be stored in the device memory. You will have a chance to submit it on the server later”. The data entered by a user will be stored in the device memory. All uncommitted data inputs will be displayed in the log(see FIG. 6). They will be marked with an icon to indicate that they are not committed.

4) The “Buy” button. When a user clicks the “Buy” button (on the screen shown in FIG. 17), a purchase confirmation screen will be presented. The purchase confirmation screen may be a standard iOS dialogue. It may prompt a user to enter his iTunes password, for example.

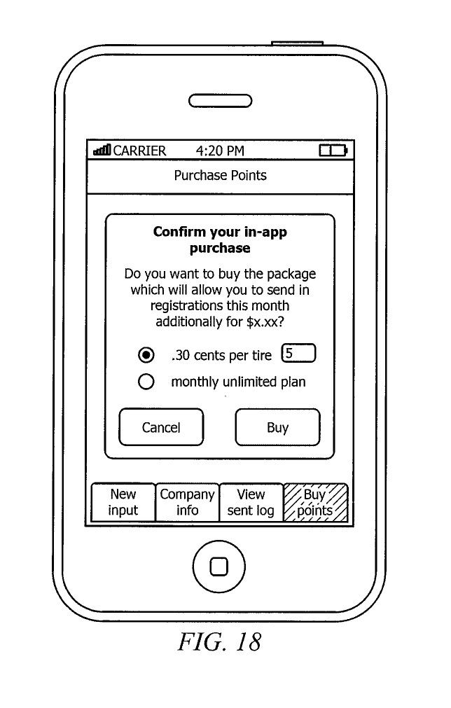

When a user clicks the “Company info” tab in the bottom navigation menu of the application's interface, the screen presented in FIG. 18 will be opened. The information specified by a user during the registration will be displayed on this screen. Initially the screen will be opened in the read-only mode. If the “Edit” button is clicked all the fields displayed on it will become editable. The “Edit” button will be replaced with the “Save” one. When a user clicks “Save” the changes he made will be saved on the server. When a user clicks “Cancel” he is directed to the page presented in FIG. 15.

When a user clicks the “View the Log Sent” tab on the bottom navigation bar of the application's interface, the screen presented in FIG. 15 will be opened. This screen contains a log of all data inputs submitted to the server or saved in the device memory. The screen will contain the following info:

1) The “Second records” header.

2) A table-view below. All the data inputs will be separated on the per-month basis. So, the corresponding record should be added there (with a title of the month and year, e.g. November 2011) at the beginning of each month.

Here also will be two other categories: “Today's activity” and “Last week's activity”. The “Today's activity” category contains a list of records submitted/saved on the device within the today's date. The “Last week's activity” will contain a list of records submitted/saved on the device memory within the last week. This category will contain a label: from <dd.mm.yy> (the current date is displayed here) till <dd.mm.yy> (the current date minus seven days is displayed here).

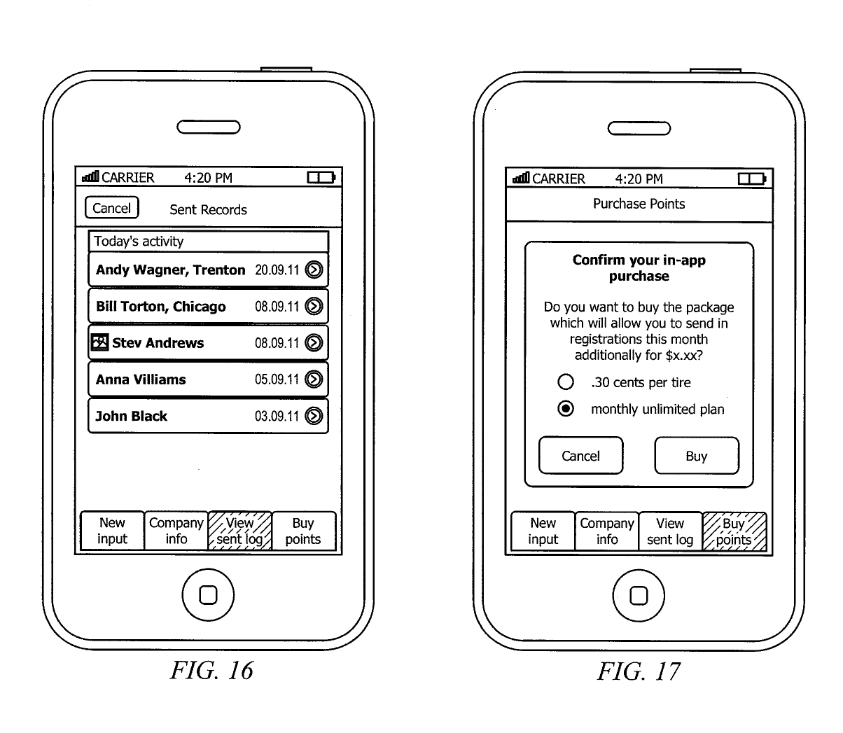

When a user clicks the “arrow” sign related to each category in the table view, the list of its records will be displayed on a new screen as it is shown in FIG. 16. This screen contains a list of exact inputs submitted to the server/saved in the device memory. Each record in the list contains the following information:

1) The Driver License owner's First name.

2) The Driver License owner's Last name.

3) The Drive License owner's city.

4) The submission date, the <dd.mm.yy> format.

Every record stored in the device memory but not submitted to the server will be marked in the list with a special icon.

Each record in the list is clickable. When clicking it the “Preview” screen (FIG. 13 or 14) it will be opened in the read-only mode. The “Edit” button will be available just for the records stored in the device memory. It will be unavailable for the records submitted already, they can be just reviewed by a user. When a user clicks the “Edit” button on this screen it will be replaced with the “Submit” one. When a user clicks “Submit” the data will be sent to the server. The confirmation dialogue will then be displayed.

As discussed above with FIG. 1, in certain embodiments the mobile application (executing on mobile device 110) is, at least temporarily, communicatively coupled with a server, such as computer 120. The functionality of the server-side application that may be running on such server computer (e.g., computer 120) in one exemplary implementation is now discussed in further detail.

Access to an administrator panel can be obtained after a successful login to the server-side application. In order to log in the administrator needs to fill in:

1) The “Username” text field (maximum 100 characters). The field is obligatory.

2) The “Password” text field (minimum 6, maximum 100 characters). The field is obligatory.

When the “Login” button is clicked the credentials entered by the admin will be checked. If the username/password is incorrect the text input fields will be highlighted with the red color, and the administrator is provided another opportunity to correctly enter the login information. In order to log out from the system the admin needs to click the “Logout” button on the server-side application's interface. The Logout link will be placed in the right upper corner of each page on the administrator panel.

The administrator's username and/or password can be changed by him/her. In order to edit them he/she needs to click an “Edit the account” link presented on the server-side application's interface. The “Edit the account” link will be placed in the right upper corner of each page on the administrator panel. When this link is clicked, a screen will be opened that contains the following elements:

1) The “Username” text field (maximum 100 characters). The field is obligatory.

2) The “Password” text field (minimum 6, maximum 100 characters). The field is obligatory.

3) The “Confirm the password” text field. The Password and Confirm the password fields should match otherwise they will be highlighted with the red color and the text will be displayed near the “Confirm the password” field: “The password does not match. Please enter it again”.

Once “Save” is clicked a new account will be saved in the database. The administrator will be directed to the Login page.

Once the admin has successfully logged in the server-side system, a page for viewing the data inputs is presented. Also this page can be accessed if the “Data Inputs” tab on the top navigation bar of the server-side application interface is clicked by the administrator. This Data Inputs page contains a list of data inputs sent from the mobile application once a user clicks the “Submit” button on the mobile application, as described above. Each record in the list contains the following info:

1) Date (dd/mm/yyyy format). The data submission date. This field should be added to each record automatically by the system when the data is submitted.

2) Dealer's Name. The field which is obtained from the mobile application's registration screen.

3) Dealer's City. The field which is obtained from the mobile application's registration screen.

4) Dealer's State. The field which is obtained from the mobile application's registration screen.

5) Dealer's ZIP. The field which is obtained from the mobile application's registration screen.

6) Driver's name. The field which is obtained from the mobile application's data input.

7) Driver's City. The field which is obtained from the mobile application's data input.

8) Driver's State. The field which is obtained from the mobile application's data input.

9) Driver's ZIP. The field which is obtained from the mobile application's data input.

10) Tire Type. The field which is obtained from the mobile application's data input.

11) Tire Number/s. The field which is obtained from the mobile application's data input. A tire number can be displayed as a text field, multiple numbers are possible, up to 4 related to each record. In case photos are taken by a user instead of manual inputting, the icon will be displayed in the cell instead of the number. When clicking this icon the application will work as described further herein.

Newly submitted records will be displayed at the top of the list. A search option, export option, and edit option is each provided (e.g., with corresponding buttons or links being presented on the server-side application's View Data Inputs screen for initiating those actions).

The search option is available for the administrator. The search will be preceded in all fields. In order to make a search, the administrator needs to enter the required word in the search fields and clicks the Enter button. The records which comply with the search conditions will be displayed in the resulting table.

The administrator also has an ability to sort out tire numbers from a selected range. In order to sort them the admin needs to enter the range of numbers in the “From” and “To” fields of the user interface. Letters and numerals are acceptable in this field. Just the records from the selected range will be displayed in the resulting table view.

In case no records can be found for a given search, the following message will be displayed: “There is no record in the selected range”.

All the information related to each record in the list can be edited by the administrator. In order to edit it, the administrator needs to click the “Edit” icon which is related to each record in the list. Once the icon is clicked the record in the list becomes editable. In order to save the edited record the administrator needs to click the Enter button.

The data inputs can be exported by the administrator to a “.pdf” or “.xls” format. In order to Export it, the admin needs to click the Export button shown. In this case, a dialogue screen will be opened, which contains the following elements:

1) The All and Date range radio buttons. When the administrator chooses “All” the records from the list of the data inputs will be exported to the selected format. When the administrator chooses the Date range a dialogue will be displayed showing the selected date range.

So, when the Date range radio-button is chosen the From and To fields and the calendar view related to them will be displayed below the radio-buttons. When the administrator clicks the picker related to the From or To fields the calendar view will be opened and the administrator will get an ability to select a date. The From date can't be later than the To date. If the administrator tries to choose them this way the following message will be displayed: “The From date can't be later than the To date”. Once the dates are set just the records from the selected interval will be exported to the selected file format.

The administrator can choose a format for exporting files to, such as the formats of .pdf or .xls can be selected by the administrator using the radio-buttons. When the administrator clicks the “Export” button, the file with the selected records in the selected format will be created and saved in the predefined directory on the administrator's server computer (e.g., computer 120 of FIG. 1). When the admin clicks the “Save as” button the standard Save as a dialogue window will be opened. Once the path is selected the file will be exported automatically. When the admin clicks the “Cancel” button the dialogue will be closed without exporting.

When the admin clicks the icon related to the records in the list of data inputs (shown on the View Data Inputs screen of the server-side application), a dialogue is presented, which contains images related to the selected data input. The maximum number of images is 4. Each image has a size of 300×400 pixels. When the admin places the mouse cursor over an image the “loop” icon will be displayed. When clicking it the image will be enlarged. The “close” icon will be placed on each image to go back to the smaller size again.

Each image contains a number placed below. This number is reflected if there are tires with the same tire numbers. The text input field is placed below images. They are intended for inputting tire numbers to them. Letters and figures are supported. At least one tire number should be registered. The “Save” button will be inactive until at least one tire number is entered to the text input field.

There is an ability to add more than one tire number. When the administrator clicks the “+” button on this dialogue screen, a new text input field will be added. There can be up to 4 tires registered per data input. Adding/deleting new fields is navigated by the “+” and “−” buttons in this exemplary implementation. When the administrator clicks “+” a new text input field is added below. In order to delete it, the administrator needs to click “−”, and the text input field will be removed.

When the admin clicks “Save”, once it becomes active, the tire numbers entered by the administrator will be added to the tire number field of the data inputs view. Also, when the “Save” button is clicked a confirmation notification will be displayed on the user's phone with the following text: “Your tires have been successfully registered”. If the application hasn't been launched so far the notification will be displayed when a user launches it.

If the “Cancel” button is clicked the dialogue will be closed without saving.

When the administrator clicks the “Purchases” tab on the server-side application interface, a page is presented that shows a list of purchases completed by all users. Each record in the list contains the following information:

1) Purchase date (dd/mm/yyyy format)

2) User's first name

3) User's last name

4) Purchase sum ($x.xx format).

Newly made purchases will be displayed at the top of the list. The paging is shown at the bottom of the page which allows the admin to navigate on pages. 30 records per page will be displayed.

When the admin clicks the “Tire Types” tab on the top navigation panel of the server-side application, a tire type page is presented. Each tire type contains the following:

1) Category name (just letters, maximum 100 characters)

2) Sub category name (just letters, maximum 100 characters)

3) Type name (just letters, maximum 100 characters)

Tire types can be searched by the administrator. The search will be preceded in the category, subcategory and the tire type fields. In order to search them, the administrator needs to enter a search word to the search field. Just the records which comply with this word will be displayed in a resulting table view.

When the administrator clicks the Add a new tire type, a page will be opened for adding a new tire. Each record contains the “Edit” and “Delete” buttons related to it. When the admin clicks “Add a new tire type” the page that is opened contains a dialogue displaying:

1) A category name (select from the list provided by the Customer). Also a new category name can be entered to the field.

2) A subcategory name (select from the list provided by the Customer). Also a new subcategory name can be entered to the field.

3) Enter a tire type name (maximum 100 characters).

When clicking “Save” a new record will be saved and added to the list. These types will be displayed then in the mobile application's interface for selecting a tire type (see FIG. 7). When clicking “Cancel” the dialogue will be closed without saving.

When the administrator clicks the “Edit” icon related to each record in the list of tire types, a dialogue screen will be opened to allow the administrator to edit the corresponding tire type. The records can be edited and the changes will be saved in the database. The list of tire types displayed in the mobile application's tire type selection interface screen will be updated as well.

When the administrator clicks the “Delete” icon related to each record in the list of tire types the record will be removed from the database. The list of tire types displayed in the mobile application's tire type selection interface screen will be updated as well.

There should be communication between the mobile application (executing on the mobile device 110) and the server-side application (executing on the server computer 120). In one exemplary implementation, this communication will be completed via web-services.

The following information is shared and stored in the server-database:

1) The user registration information. In case the registration information is changed, the changes are saved on the server as well. The data is saved on the server once a user clicks the “Submit” button on the mobile application interface.

2) The tire types, as may be edited by the administrator in the above-described manner.

3) The purchase history information, as discussed above, is also stored in the server-side database.

It should be recognized that the description of the exemplary embodiment/implementation provided above in connection with FIGS. 3-18 is merely one illustrative example of a solution that may be implemented in accordance with the concepts disclosed herein, and the scope of the present invention is not intended to be limited in any way to the specific details described in connection with that illustrative example.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A tire registration system comprising:
a consumer information capture component, said consumer information capture component configured to autonomously capture information pertaining to a consumer of at least one tire;
a tire information capture component, said tire information capture component configured to autonomously capture information relating to said at least one tire; and
a processing device configured to receive information from said consumer information capture component and said tire information capture component, said processing device further configured to populate one or more registration fields for completing tire registration information.

2. The tire registration system of claim 1 wherein said tire information capture component includes a digital image capture device.

3. The tire registration system of claim 2 wherein said tire information capture component is configured to recognize text in a digital image obtained by said digital image capture device.

4. The tire registration system of claim 1 wherein said tire information capture component includes a radio frequency identification (RFID) reader.

5. The tire registration system of claim 4 wherein said RFID reader is further configured to capture said consumer information from a card corresponding to a particular consumer.

6. The tire registration system of claim 1 wherein said tire information capture component includes an infrared scanner.

7. The tire registration system of claim 1 wherein said consumer information capture component comprises a card reader configured to obtain said consumer information from a card corresponding to said consumer.

8. The tire registration system of claim 7 wherein said card reader comprises a drivers license reader.

9. The tire registration system of claim 7 wherein said card reader comprises a credit card reader.

10. The tire registration system of claim 7 wherein said consumer information capture component further comprises a manual entry component.

11. The tire registration system of claim 1 wherein said processing device is further configured to transmit registration information to a third party registration system.

12. A method for performing tire registration, the method comprising:
capturing, by a consumer information capture component of a mobile processor-based device, information pertaining to a consumer of at least one tire, wherein said consumer information capture component comprises a drivers license reader and wherein said capturing comprises capturing information about said consumer from a drivers license;
capturing, by a tire information capture component of said mobile processor-based device, information relating to said at least one tire; and
populating, by a processing device, one or more registration fields of an electronic tire registration form with said captured consumer information and said captured tire information.

13. The method of claim 12 further comprising:
electronically communicating said electronic tire registration form over a communication network from said processing device to a server device.

14. The method of claim 13 wherein said server device is a server device of a tire registration authority.

15. The method of claim 12 wherein said tire information capture component includes a digital image capture device, and wherein said capturing said information relating to said at least one tire comprises capturing an image of at least a portion of said at least one tire by said digital image capture device.

16. The method of claim 15 further comprising:
processing said image to perform optical character recognition to recognize text present in said image, wherein said recognized text comprises at least part of said captured information relating to said at least one tire.

17. A mobile processor-based device for assisting in tire registration, the mobile processor-based device comprising:
a consumer information capture component that comprises a drivers license reader that is operable to capture information from a drivers license about a consumer of at least one tire, wherein said captured consumer information is information for registering said at least one tire; and
a tire information capture component operable to capture information relating to said at least one tire, wherein said captured tire information is information for registering said at least one tire.

18. The mobile processor-based device of claim 17 wherein said tire information capture component includes a digital image capture component for capturing an image of at least a portion of said at least one tire.

19. The mobile processor-based device of claim 18 further comprising:
optical character recognition (OCR) component operable to process said image of said at least a portion of said at least one tire captured by said digital image capture component to recognize text present in said image, wherein said recognized text comprises at least part of said captured information relating to said at least one tire.

20. The mobile processor-based device of claim 17 further comprising:
means for populating one or more registration fields of an electronic tire registration form with said captured consumer information and said captured tire information.

21. The mobile processor-based device of claim 20 wherein said populating means comprises a communication interface with another processor-based device via which said mobile processor-based device communicates said captured consumer information and said captured tire information to said another processor-based device, and wherein said another processor-based device populates said one or more registration fields of the electronic tire registration form with said captured consumer information.

22. The mobile processor-based device of claim 20 further comprising:
means for electronically communicating said electronic tire registration form over a communication network to a server device.

23. The mobile processor-based device of claim 22 wherein said means for electronically communicating comprises a communication interface with another processor-based device, wherein said another processor-based device communicates said electronic tire registration form over said communication network to said server device.

24. The mobile processor-based device of claim 22 wherein said server device comprises a server device of a tire registration authority.
